(19) United States
(12) Patent Application Publication
(10) Pub. No.: US 2005/0083985 A1
(43) Pub. Date: Apr. 21, 2005

(54) Turbo-blower for laser medium gas

(75) Inventors: Akira Egawa, Gotenba-shi (JP); Tsutomu Funakubo, Fujiyoshida-shi (JP); Kazuya Ohta, Fujiyoshida-shi (JP)

Correspondence Address: BURNS DOANE SWECKER & MATHIS L L P, POST OFFICE BOX 1404, ALEXANDRIA, VA, 22313-1404, US

(73) Assignee: FANUC LTD., Minamitsuru-gun (JP)

(21) Appl. No.: 10/965,205

(22) Filed: Oct. 15, 2004

(30) Foreign Application Priority Data
Oct. 17, 2003 (JP) 2003-357812

(51) Int. Cl. H01S 3/22

(52) U.S. Cl. 372/58

(57) ABSTRACT

A turbo-blower for use with a laser oscillator to provide a flow of a laser medium gas under pressure. The turbo-blower includes an impeller with a rotation axis, the impeller sucking a laser medium gas in an axial direction and discharging the laser medium gas in a radial outward direction; a casing including a gas passage for providing a spiral flow of the laser medium gas discharged from the impeller; and a collecting section provided in the casing and including a chamber fluidly communicated with the gas passage, the collecting section collecting particulates contained in the laser medium gas into the chamber due to a centrifugal force generated in the laser medium gas flowing through the gas passage. The chamber of the collecting section is fluidly communicated with the gas passage through a slit locally formed in a wall of the casing.

### BACKGROUND OF THE INVENTION

1. Field of the Invention

The present invention relates to a laser oscillator for a gas laser and, more particularly, to a turbo-blower for forcibly circulating a laser medium gas in a medium circuit.

2. Description of the Related Art

In a laser oscillator for a gas laser used in the fields of laser machining, medical treatment, illumination or data communications, it is known that a turbo-blower, incorporated as blowing means, forcibly circulates a flowing gas as a medium (referred to as a laser medium gas in this application) in a medium circuit. The laser oscillator for a gas laser generally includes an excitation section formed between an opposing pair of reflecting mirrors, and a suction port and a discharge port of the turbo-blower are connected to the excitation section through a circulation path so as to form the medium circuit. In general, heat exchangers for cooling the laser medium gas are arranged at the upstream and downstream sides of the turbo-blower in the circulation path. An electric discharge generated between a pair of electrodes arranged in the excitation section is generally used as excitation means in the excitation section. The other means such as light, heat, chemical reaction, etc., may also be used as the excitation means, depending on the type of a laser medium gas.

In the conventional laser oscillator as described above, there may be a case where foreign matter such as dust (or particulates) is mixed in the laser medium gas flowing through the circulation path due to various factors. For example, it is difficult to completely eliminate disadvantages such as the penetration of dust from environmental air into the circulation path during the maintenance of the laser oscillator, or the generation of particulates within the circulation path due to wear of the components of the oscillator. The particulates presenting in the circulation path of the laser oscillator are generally not removed but circulate through the medium circuit together with the laser medium gas, and may be fixed to optical parts such as the reflecting mirrors in the excitation section, which may cause a reduction in a laser beam output or deterioration of the optical parts.

When the laser output drops, the optical parts such as the reflecting mirrors generally need to be taken out for cleaning, but such maintenance work requires an operator's skill and a lot of time for adjustment upon reinstalling the optical parts. Moreover, in the case of a larger output laser, if the reflecting mirror to which foreign matter has affixed is irradiated with a laser beam, the mirror may be damaged. In this case, the reflecting mirror must be exchanged. Therefore, it is desired that the particulates mixed in the laser medium gas are automatically removed from the circulation path of the laser oscillator.

### SUMMARY OF THE INVENTION

It is an object of the present invention to provide a turbo-blower for a laser medium gas used in a laser oscillator, which includes inexpensive particulate removing means, having a simple structure, capable of preventing particulates contained in the laser medium gas from soiling or damaging the optical parts of the laser oscillator.

It is another object of the present invention to provide a laser oscillator provided with such a turbo-blower and thus possessing excellent operational reliability and maintainability.

To accomplish the above object, the present invention provides a turbo-blower for use with a laser oscillator to provide a flow of a laser medium gas under pressure, comprising an impeller with a rotation axis, the impeller sucking a laser medium gas in an axial direction and discharging the laser medium gas in a radial outward direction; a casing including a gas passage for providing a spiral flow of the laser medium gas discharged from the impeller; and a collecting section provided in the casing and including a chamber fluidly communicated with the gas passage, the collecting section collecting particulates contained in the laser medium gas into the chamber due to a centrifugal force generated in the laser medium gas flowing through the gas passage.

In the above turbo-blower, the chamber of the collecting section may be arranged outside of the gas passage as seen in a radial direction of the impeller.

Alternatively, the chamber of the collecting section may be arranged to be superimposed with the gas passage as seen in an axial direction of the impeller.

Also, the chamber of the collecting section may be fluidly communicated with the gas passage through a slit locally formed in a wall of the casing.

The above turbo-blower may further comprise a flow regulating valve provided in association with the gas passage, the flow regulating valve regulating a flow rate of the laser medium gas flowing through the gas passage to allow selection of the particulates collected into the chamber.

Alternatively, the above turbo-blower may further comprise a speed-controllable drive source capable of driving the impeller at a variable speed to allow selection of the particulates collected into the chamber.

The present invention also provides a laser oscillator for a gas laser, comprising a circulation path accommodating a lased medium gas in a flowable manner; an excitation section connected to the circulation path and exciting the laser medium gas; and a blowing mechanism connected to the circulation path and forcibly supplying the laser medium gas into the excitation section; the blowing mechanism comprising a turbo-blower as set forth in claim 1.

### BRIEF DESCRIPTION OF THE DRAWINGS

The above and other objects, features and advantages of the present invention will become more apparent from the following description of preferred embodiments in connection with the accompanying drawings, wherein:

FIG. 1 is a diagram typically showing an embodiment of a laser oscillator including a turbo-blower according to the present invention;

FIGS. 2A and 2B are diagrams typically showing a turbo-blower according to a first embodiment of the present invention;

FIGS. 3A and 3B are diagrams typically showing a turbo-blower according to a second embodiment of the present invention;

FIGS. 4A to 4C are diagrams typically showing a turbo-blower according to a third embodiment of the present invention;

FIGS. 5A and 5B are diagrams typically showing a turbo-blower according to a fourth embodiment of the present invention;

FIGS. 6A to 6C are diagrams typically showing a turbo-blower according to a fifth embodiment of the present invention; and

FIGS. 7A and 7B are diagrams typically showing a turbo-blower according to a sixth embodiment of the present invention.

### DETAILED DESCRIPTION

The embodiments of the present invention are described below in detail, with reference to the accompanying drawings. In the drawings, the same or similar components are denoted by common reference numerals.

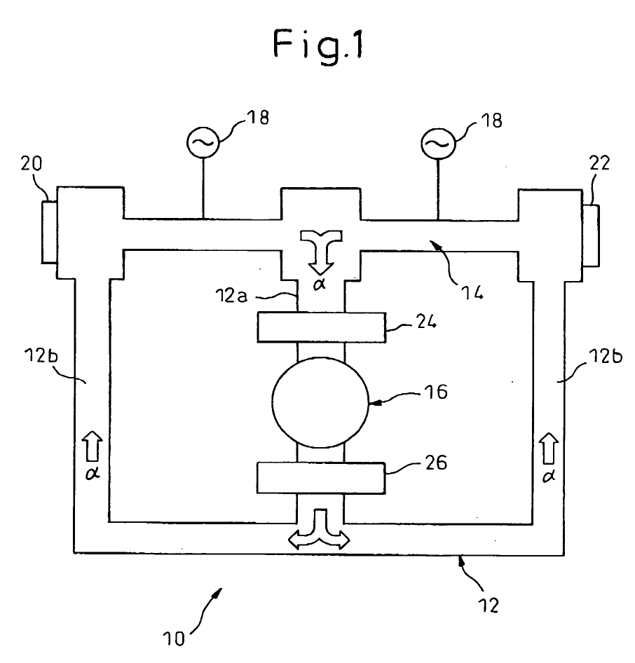

Referring to the drawings, FIG. 1 typically shows an embodiment of a laser oscillator including a turbo-blower according to the present invention. The laser oscillator 10 of the illustrated embodiment is a gas laser oscillator, and includes a circulation path 12 accommodating a lased medium gas in a flowable manner; an excitation section 14 connected to the circulation path 12 and exciting the laser medium gas; and a blowing mechanism 16 connected to the circulation path 12 and forcibly supplying the laser medium gas into the excitation section 14. The blowing mechanism 16 includes a turbo-blower having a rotary impeller, which will be described later. It should be noted that the term “blower” used in this application means any blowing machine that is not classified by, e.g., a pressure increasing value for a gas.

The excitation section 14 is configured as an electric discharge tube including a pair of electrodes (not shown) connected to a pair of alternating current power supplies 18, and a pair of reflecting mirrors (i.e., a rear mirror 20 and an output mirror 22) are arranged at longitudinally opposite ends of the excitation section 14. The circulation path 12 includes a central part 12a and opposite end parts 12b connected respectively to the generally center and opposite ends of the excitation section 14 in the longitudinal direction, and the blowing mechanism 16 including the turbo-blower is incorporated into the central part 12a. The blowing mechanism 16 is provided with a suction port at the side communicating with the generally center of the excitation section 14 through the central part 12a of the circulation path 12 and with a discharge port at the side communicating with the opposite ends of the excitation section 14 through the opposite end parts 12b of the circulation path 12.

The circulation path 12, the excitation section 14 and the blowing mechanism 16 constitute a closed circuit (or a medium circuit) enclosing the laser medium gas. When the blowing mechanism 16 operates, the laser medium gas is forced to flow and circulate at a high speed through the medium circuit under a certain pressure (shown by an arrow α). In this connection, heat exchangers 24, 26 for cooling the laser medium gas are arranged at the upstream and downstream sides of the blowing mechanism 16, respectively, in the central part 12a of the circulation path 12.

In the excitation section 14, when the alternating current power supplies 18 are turned on so as to generate an electrical discharge between the electrodes, the laser medium gas is excited (or pumped) and a laser beam is thus produced. The laser medium gas, the temperature of which is increased by the electrical discharge, is cooled by the heat exchanger 24 at the upstream side of the blowing mechanism 16, and is sucked into the blowing mechanism 16. The blowing mechanism 16 applies pressure to the laser medium gas so as to move the medium gas to the discharge side. The laser medium gas, the temperature of which is increased during the compression process, is cooled again by the heat exchanger 26 at the downstream side of the blowing mechanism 16, and is supplied to the excitation section 14 through the circulation path 12.

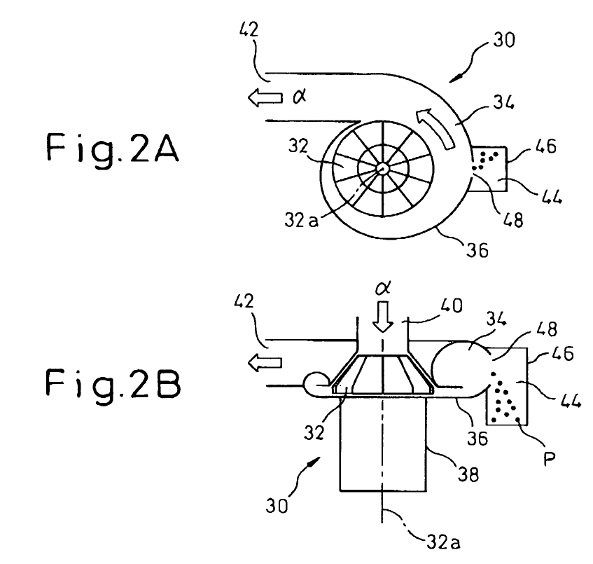

In the laser oscillator 10 having the above-described configuration, there may be a case where foreign matter such as dust (or particulates) is mixed in the laser medium gas flowing through the circulation path 12 due to the various factors as described above. In the laser oscillator 10, the turbo-blower according to the present invention having the following characteristic configuration is employed as the blowing mechanism 16, so as to automatically remove the particulates in the laser medium gas during a period when the laser medium gas circulates, and to eliminate disadvantages such as the damage to or soiling of the optical parts (e.g., the rear mirror 20 and the output mirror 22). various preferred embodiments of the turbo-blower according to the present invention are explained below with reference to FIGS. 2A to 7B.

FIGS. 2A and 2B typically show a turbo-blower 30, according to a first embodiment of the present invention, wherein FIG. 2A schematically shows the major construction of a blower interior, as a plan view shown in perpendicular to an impeller rotation axis, and FIG. 2B schematically shows the major construction of the blower interior, as an elevational view shown in parallel to the impeller rotation axis. The turbo-blower 30 of the first embodiment has a configuration in which an impeller 32 is arranged in such a manner that a rotation axis 32a thereof is oriented in a generally vertical direction (or in the direction of gravity).

The turbo-blower 30 includes the impeller 32 sucking a laser medium gas in an axial direction and discharging the laser medium gas in a radial outward direction, and a casing 36 including a gas passage 34 for providing a spiral flow of the laser medium gas discharged from the impeller 32. The impeller 32 has a centrifugal structure with the rotation axis 32a, and is driven for rotation by a drive source 38 such as an electric motor. The casing 36 is provided, at a side opposite to the drive source 38, with a suction port 40 that opens toward the center of rotation of the impeller 32. The gas passage 34 is a spiral portion extending along the outer periphery of the impeller 32 as a scroll (i.e., the sectional area of the passage increases gradually), and serves to efficiently recover the pressure energy of the laser medium gas discharged radially from the impeller 32, in a passage length extending up to a discharge port 42 at the distal end of the gas passage. When the impeller 32 is driven for rotation by the drive source 38, the laser medium gas is sucked through the suction port 40, and passes through the gas passage 34 so as to be discharged from the discharge port 42 (as shown by the arrow α).

The turbo-blower 30 also includes a collecting section 46 provided in the casing 36 and including a chamber 44 fluidly communicated with the gas passage 34. The collecting section 46 is a box-shaped member arranged at a suitable position in the outer peripheral side of the casing 36 as seen in the radial direction of the impeller 32. The chamber 44 is arranged outside of the gas passage 34 as seen in the radial direction of the impeller 32, and fluidly communicates with the gas passage 34 through a slit 48 formed locally in the outer peripheral wall of the casing 36. The collecting section 46 and the slit 48 serve to collect or entrap particulates P, contained in the laser medium gas sucked into the turbo-blower 30, into the chamber 44 due to a centrifugal force generated in the laser medium gas flowing through the gas passage 34.

More specifically, the laser medium gas containing the particulates P such as dust and sucked through the suction port 40, is thereafter compressed by the rotating impeller 32, so as to flow spirally at a high speed under a certain pressure along the gas passage 34. At this stage, the particulates P having mass larger than that of the laser medium gas are carried, in the laser medium gas flowing at a high speed, in such a manner as to be urged by centrifugal force against the radially outward interior surface of the casing 36 defining the gas passage 34. At an instant when the particulates P reach the slit 48, they pass through the slit 48 while being separated from the laser medium gas, and are collected or entrapped in the chamber 44 of the collecting section 46 so as to be deposited therein.

In this connection, the collecting section 46 is hermetically sealed, except for the slit 48, and is configured so that the inner pressure of the collecting section 46 can be easily raised higher than the inner pressure of the gas passage 34. Therefore, the laser medium gas is substantially not introduced into the chamber 44 through the slit 48, but flows through the gas passage 34 so as to be surely discharged from the discharge port 42. In this manner, pure laser medium gas, from which the particulates P have been removed, is discharged from the discharge port 42 of the turbo-blower 30 under a predetermined pressure, and supplied, for example, to the circulation path 12 of the laser oscillator 10 shown in FIG. 1. As for the slit 48, which serves as a communication hole through which the chamber 44 of the collecting section 46 communicates with the gas passage 34, it is possible to provide two or more slits per one collecting section 46.

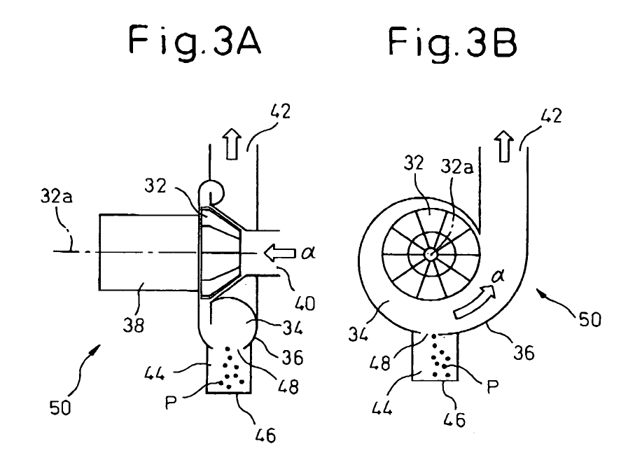

FIGS. 3A and 3B typically show a turbo-blower 50 according to a second embodiment of the present invention, wherein FIG. 3A schematically shows the major construction of a blower interior, as an elevational view shown in parallel to an impeller rotation axis, and FIG. 3B schematically shows the major construction of the blower interior, as an elevational view shown in perpendicular to the impeller rotation axis. The turbo-blower 50 of the second embodiment has a configuration substantially identical to the turbo-blower 30 of the first embodiment, except that an impeller 32 is arranged in such a manner that a rotation axis 32a thereof is oriented in a generally horizontal direction. Therefore, corresponding components are denoted by common reference numerals and the descriptions thereof are not repeated.

In the turbo-blower 50, a collecting section 46 and a slit 48, for collecting or entrapping particulates P, contained in a laser medium gas, in a chamber 44 due to a centrifugal force, are arranged beneath the casing 36 as seen in the direction of gravity. According to the turbo-blower 50 having such a configuration, it is also possible to obtain the function and effect equivalent to those obtained from the turbo-blower 30 described above. Particularly, in the turbo-blower 50, as the collecting section 46 and the slit 48 are arranged beneath the casing 36, the particulates P in the laser medium gas flowing through the gas passage 34 are introduced into the chamber 44 through the slit 48 due to gravity, in addition to the centrifugal force due to the rotation of the impeller 32. As a result, it is possible to more efficiently collect or entrap the particulates P contained in the laser medium gas into the collecting section 46 via the slit 48.

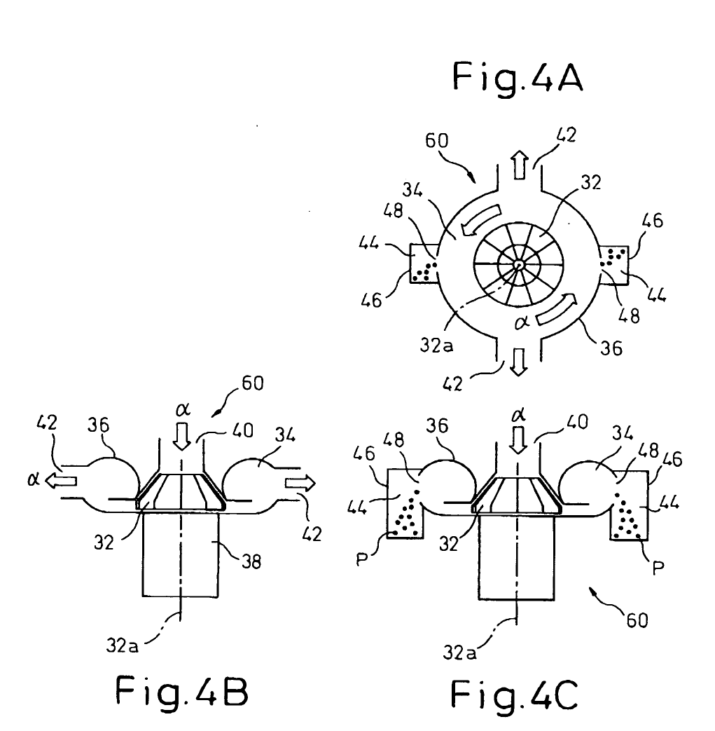

FIGS. 4A to 4C typically show a turbo-blower 60 according to a third embodiment of the present invention, wherein FIG. 4A schematically shows the major construction of a blower interior, as a plan view shown in perpendicular to an impeller rotation axis, FIG. 4B schematically shows the major construction of the blower interior at a location of a discharge port 42, as an elevational view shown in parallel to the impeller rotation axis, and FIG. 4C schematically shows the major construction of the blower interior at a location of a collecting section 46, as an elevational view shown in parallel to the impeller rotation axis. The turbo-blower 60 of the third embodiment has a configuration substantially identical to the turbo-blower 30 of the first embodiment, except for the provision of plural discharge ports 42 and plural collecting sections 46. Therefore, corresponding components are denoted by common reference numerals and the descriptions thereof are not repeated.

The turbo-blower 60 has a configuration in which an impeller 32 is arranged in such a manner that a rotation axis 32a thereof is oriented in a generally vertical direction (or in the direction of gravity). A gas passage 34 extending along the outer periphery of the impeller 32 is formed as a circular and annular passage having a substantially constant sectional area over the entire length thereof. A casing 36 is provided with a pair of discharge ports 42, at which the gas passage 34 opens, located oppositely to each other with the rotation axis 32a of the impeller 32 being disposed at a midpoint thereof. The collecting sections 46 and the slits 48 are provided in the casing 36 at predetermined positions upstream, in a gas flowing direction, of the respective discharge ports 42.

When the impeller 32 is driven for rotation by a drive source 38, the laser medium gas is sucked through a suction port 40, flows spirally at a high speed through the gas passage 34, and is discharged from the respective discharge ports 42 (as shown by the arrow α). At this stage, before the laser medium gas is discharged from the respective discharge ports 42, the particulates P contained in the laser medium gas penetrate through the corresponding slits 48, while being separated from the laser medium gas by centrifugal force, and are collected or entrapped in the chamber 44 of the collecting section 46. As a result, the pure laser medium gas, that does not contain the particulates P, is discharged from the respective discharge ports 42.

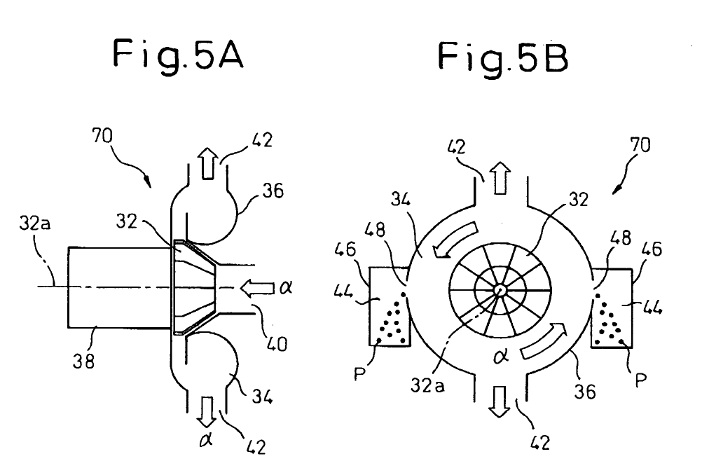

FIGS. 5A and 5B typically show a turbo-blower 70 according to a fourth embodiment of the present invention, wherein FIG. 5A schematically shows the major construction of a blower interior, as an elevational view parallel to an impeller rotation axis, and FIG. 5B schematically shows the major construction of the blower interior, as an elevational view perpendicular to the impeller rotation axis. The turbo-blower 70 of the fourth embodiment has a configuration substantially identical to the turbo-blower 60 of the third embodiment, except that an impeller 32 is arranged in such a manner that a rotation axis 32a thereof is oriented in a generally horizontal direction. Therefore, corresponding components are denoted by the common reference numerals and the descriptions thereof are not repeated. Using the turbo-blower 70 having such a configuration, it is also possible to obtain the function and effect equivalent to those obtained from the turbo-blower 60 described above.

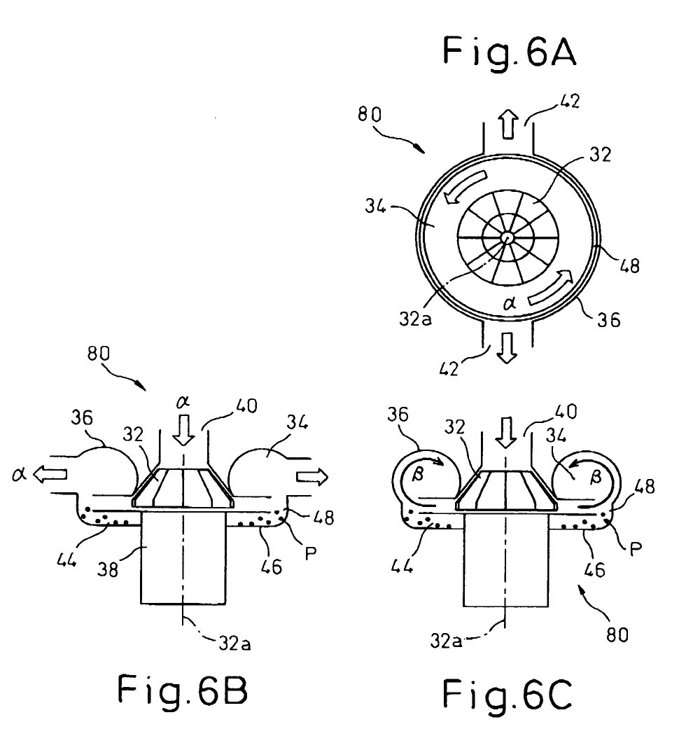

FIGS. 6A to 6C typically show a turbo-blower 80 according to a fifth embodiment of the present invention, wherein FIG. 6A schematically shows the major construction of a blower interior, as a plan view shown in perpendicular to an impeller rotation axis, FIG. 6B schematically shows the major construction of the blower interior at a location of a discharge port 42, as an elevational view shown in parallel to the impeller rotation axis, and FIG. 6C schematically shows the major construction of the blower interior at a location other than the discharge port 42, as an elevational view shown in parallel to the impeller rotation axis. The turbo-blower 80 of the fifth embodiment has a configuration substantially identical to the turbo-blower 60 of the third embodiment, except for the configurations of a collecting section 46 and of a slit 48. Therefore, corresponding components are denoted by the common reference numerals and the descriptions thereof are not repeated.

The turbo-blower 80 has a configuration in which an impeller 32 is arranged in such a manner that a rotation axis 32a thereof is oriented in a generally vertical direction (or in the direction of gravity). The collecting section 46 is an annular member arranged beneath a casing 36 as seen in the axial direction of the impeller 32. A chamber 44 is arranged to be superimposed with a gas passage 34 as seen in the axial direction of the impeller 32 over the generally entire length of the circular and annular gas passage 34, and fluidly communicates with the gas passage 34 through the slit 48 formed in an annular shape extending along the outer peripheral wall of the casing 36. The collecting section 46 and the slit 48 serve to collect or entrap the particulates P, contained in the laser medium gas sucked into the turbo-blower 80, into the chamber 44 under a centrifugal force generated in the laser medium gas flowing through the gas passage 34.

When the impeller 32 is driven for rotation by a drive source 38, the laser medium gas is sucked through the suction port 40, flows spirally at high speed through the gas passage 34, and is discharged from each of a pair of discharge ports 42 (shown by the arrow α). At this stage, before the laser medium gas is discharged from the respective discharge ports 42, the particulates P contained in the laser medium gas penetrate through the annular slit 48, while being separated from the laser medium gas by the centrifugal force, and are collected or entrapped in the circular and annular chamber 44 of the collecting section 46. As a result, the pure laser medium gas, that does not contain the particulates P, is discharged from the respective discharge ports 42.

In this connection, the laser medium gas flowing through the gas passage 34 collides with the radially outward interior surface of the casing 36 defining the gas passage 34, after being discharged in the radial direction from the impeller 32, and flows toward the upper space of the gas passage 34, as shown by an arrow β in FIG. 6C. Therefore, due to the provision of the annular slit 48 along the outer periphery of the gas passage 34, at which the laser medium gas tends to flow toward the upper space, the particulates P can penetrate through the slit 48 and are accumulated in the collecting section 46 by the effect of the gravity in addition to the centrifugal force. In this regard, a single slit 48 or a plurality of separated slits 48 may be provided at a desired location in the circumferential direction of the gas passage 34, instead of the annular slit 48.

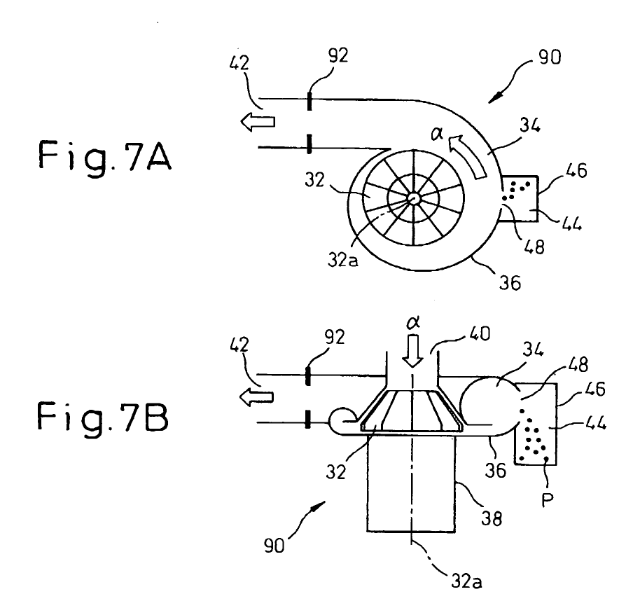

FIGS. 7A and 7B typically show a turbo-blower 90 according to a sixth embodiment of the present invention, wherein FIG. 7A schematically shows the major construction of a blower interior, as a plan view perpendicular to an impeller rotation axis, and FIG. 7B schematically shows the major construction of the blower interior, as an elevational view parallel to the impeller rotation axis. The turbo-blower 90 of the sixth embodiment has a configuration substantially identical to the turbo-blower 30 of the first embodiment, except for the provision of means for adjusting a flow rate of a laser medium gas flowing through a gas passage. Therefore, corresponding components are denoted by the common reference numerals and the descriptions thereof are not repeated.

The turbo-blower 90 is provided with a flow regulating valve 92 for regulating the flow rate, or the compression ratio, of the laser medium gas flowing through the gas passage 34, in the vicinity of the discharge port 42 at the distal end of the gas passage 34. The flow regulating valve 92 is able to regulate the flow rate, or the compression ratio, of the laser medium gas flowing through the gas passage 34 by suitably controlling the valve opening and, thereby, to change the centrifugal force applied to the particulates P contained in the laser medium gas. As a result, in the turbo-blower 90, it is possible to select the particulates P, which would be collected in the chamber 44 of the collecting section 46, in association with the desired diameter or mass of a particle.

For example, if the flow regulating valve 92 is turned to a throttling position so as to increase the compression ratio of the laser medium gas by the impeller 32, the flow rate (or the velocity) of the laser medium gas flowing through the gas passage 34 is reduced. As a result, the centrifugal force generated in the laser medium gas in the gas passage 34 is decreased, so that, for example, of particulates P having the equal diameter, the particulate having a relatively small mass cannot reach the slit 48 and thus is not collected or entrapped in the collecting section 46, while the particulate having a relatively large mass is collected in the collecting section 46. In this regard, the flow regulating valve 92 is not limitedly arranged at the location adjacent to the discharge port 42, but may be arranged at various locations in association with the gas passage 34, such as a location adjacent to the suction port 40 or a desired location in the gas passage 34.

Instead of the provision of the flow regulating valve 92, a speed-controllable drive source 38 capable of driving the impeller 38 at a variable rotation speed may be employed as the drive source 38 of the impeller 32. In this case, it is possible for the flow rate, or the compression ratio, of the laser medium gas flowing through the gas passage 34 to be regulated by suitably controlling the rotation speed of the impeller 32, so that it is possible to change the centrifugal force applied to the particulates P contained in the laser medium gas, and thus to select the particulates P, which would be collected in the chamber 44 of the collecting section 46, in association with the desired diameter or mass of a particle. It should be noted that the above-described flow rate adjusting means for the laser medium gas can also be applied to the turbo-blowers 50, 60, 70, and 80 in the second to fifth embodiments and, thereby, a similar function and effect can be obtained.

As will be apparent from the above description, in the turbo-blower for a laser medium gas used in a laser oscillator, according to the present invention, the collecting section :provided in the casing serves to automatically collect or entrap the particulates contained in the laser medium gas flowing through the gas passage into the chamber, so that it is possible to surely prevent the particulates contained in the laser medium gas from damaging or soiling optical components in the laser oscillator. It is also possible to sufficiently remove the particulates in the laser medium gas by a simple inexpensive structure in which merely the collecting section is provided in the casing. Further, the laser oscillator according to the present invention and including the above-described turbo-blower possesses excellent operational reliability and maintainability.

While the invention has been described with reference to specific preferred embodiments, it will be understood by those skilled in the art that various changes and modifications may be made thereto without departing from the spirit and scope of the following claims. For example, the configuration of the collecting section for automatically collecting the particulates contained in the laser medium gas may be preferably applied to a turbo-blower including not only the centrifugal impeller but also any other type of impeller, such as a mixed-flow impeller, provided that it is able to suck the laser medium gas in an axial direction and discharge the laser medium gas in a radial outward is direction.

1. A turbo-blower for use with a laser oscillator to provide a flow of a laser medium gas under pressure, comprising:
an impeller with a rotation axis, said impeller sucking a laser medium gas in an axial direction and discharging the laser medium gas in a radial outward direction;
a casing including a gas passage for providing a spiral flow of the laser medium gas discharged from said impeller; and
a collecting section provided in said casing and including a chamber fluidly communicated with said gas passage, said collecting section collecting particulates contained in the laser medium gas into said chamber due to centrifugal force generated in the laser medium gas flowing through said gas passage.

2. A turbo-blower as set forth in claim 1, wherein said chamber of said collecting section is arranged outside of said gas passage as seen in a radial direction of said impeller.

3. A turbo-blower as set forth in claim 1, wherein said chamber of said collecting section is arranged to be superimposed with said gas passage as seen in an axial direction of said impeller.

4. A turbo-blower as set forth in claim 1, wherein said chamber of said collecting section is fluidly communicated with said gas passage through a slit locally formed in a wall of said casing.

5. A turbo-blower as set forth in claim 1, further comprising a flow regulating valve provided in association with said gas passage, said flow regulating valve regulating a flow rate of the laser medium gas flowing through said gas passage to allow selection of the particulates collected into said chamber.

6. A turbo-blower as set forth in claim 1, further comprising a speed-controllable drive source capable of driving said impeller at a variable speed to allow selection of the particulates collected into said chamber.

7. A laser oscillator for a gas laser, comprising:
a circulation path accommodating a laser medium gas in a flowable manner;
an excitation section connected to said circulation path and exciting the laser medium gas; and
a blowing mechanism connected to said circulation path and forcibly supplying the laser medium gas into said excitation section;
said blowing mechanism comprising a turbo-blower as set forth in claim 1.
